(19) United States
(12) Patent Application Publication
(10) Pub. No.: US 2019/0065834 A1
(43) Pub. Date: Feb. 28, 2019

(54) APPARATUS AND METHOD FOR CONFIGURABLE AUTOMATED DISTRIBUTION OF IMAGES

(71) Applicant: Incode Technologies, Inc., San Francisco, CA (US)

(72) Inventors: Ricardo Amper, San Francisco, CA (US); Aleksei Golunov, San Francisco, CA (US); Jovan Jovanovic, San Francisco, CA (US); Erick Camacho, San Francisco, CA (US)

(73) Assignee: Incode Technologies, Inc., San Francisco, CA (US)

(21) Appl. No.: 16/109,322

(22) Filed: Aug. 22, 2018

Related U.S. Application Data
(60) Provisional application No. 62/548,880, filed on Aug. 22, 2017.

(51) Int. Cl. G06K 9/00; G06N 3/04; G06Q 50/00

(52) U.S. Cl. CPC G06K 9/00288; G06Q 50/01; G06N 3/04; G06K 9/00248

(57) ABSTRACT

An apparatus has a processor and a network interface circuit connected to the processor to provide connectivity to a network. A memory is connected to the processor and the network interface circuit. The memory stores instructions executed by the processor to receive a digital image. Facial templates are created for faces in the digital image. The facial templates are compared to a user facial template collection to selectively identify matches between the facial templates and stored user facial templates in the user facial template collection. Image distribution criteria for the matches is evaluated. The digital image is sent to the network for distribution to selective client device in accordance with the image distribution criteria. New facial templates from the digital image that do not correspond to stored user facial templates in the user facial template collection are uploaded to a server via the network.

### CROSS-REFERENCE TO RELATED APPLICATION

This application claims priority to U.S. Provisional Patent Application Ser. No. 62/548,880, filed Aug. 22, 2017, the contents of which are incorporated herein by reference.

### FIELD OF THE INVENTION

This invention relates generally to communications in computer networks. More particularly, this invention is directed toward configurable automated distribution of images in computer networks.

### BACKGROUND OF THE INVENTION

Digital devices that include cameras have become ubiquitous. As a consequence, images taken by digital device users are growing exponentially. Thus, there is a growing need for a mechanism to easily distribute interesting instances of such images.

### SUMMARY OF THE INVENTION

An apparatus has a processor and a network interface circuit connected to the processor to provide connectivity to a network. A memory is connected to the processor and the network interface circuit. The memory stores instructions executed by the processor to receive a digital image. Facial templates are created for faces in the digital image. The facial templates are compared to a user facial template collection to selectively identify matches between the facial templates and stored user facial templates in the user facial template collection. Image distribution criteria for the matches is evaluated. The digital image is sent to the network for distribution to selective client device in accordance with the image distribution criteria. New facial templates from the digital image that do not correspond to stored user facial templates in the user facial template collection are uploaded to a server via the network.

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 2 illustrates individual image processing performed in accordance with an embodiment of the invention.

FIG. 3 illustrates client device batch processing of images in accordance with an embodiment of the invention.

FIG. 4 illustrates server batch processing of images in accordance with an embodiment of the invention.

Like reference numerals refer to corresponding parts throughout the several views of the drawings.

### DETAILED DESCRIPTION OF THE INVENTION

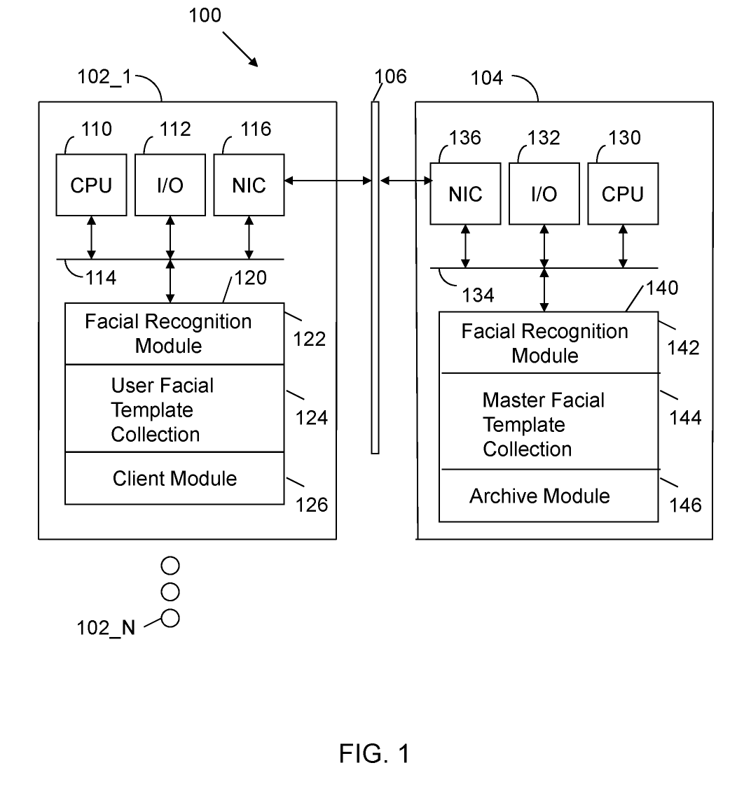

FIG. 1 illustrates a system 100 configured in accordance with an embodiment of the invention. The system 100 includes a set of client devices 102_1 through 102_N in communication with a server 104 via a network 106, which may be any combination of wired and wireless networks. Each client device 102_1 through 102_N includes a processor 110 and input/output devices 112 connected via a bus 114. The input/output devices 112 may include a keyboard, camera (e.g., a charge coupled device camera) touch display, and the like. A network interface circuit 116 is also connected to the bus 114 to provide connectivity to network 106.

A memory 120 is also connected to bus 114. The memory 120 stores data and instructions to implement operations disclosed herein. In particular, the memory 120 stores a facial recognition module 122 with instructions executed by processor 110 to create facial templates for faces within a digital image. This results in a user facial template collection 124. The user facial template collection 124 has stored user facial templates for individuals that appear in digital images processed by the facial recognition module 122.

The memory 120 also stores a client module 126. The client module 126 is a client side application to implement operations disclosed herein, such as finding matches between individuals in a new digital image and individuals in the user facial template collection 124, selectively distributing digital images that have matched individuals, communicating with other client devices to obtain additional digital images and communicating with server 104, as detailed below.

The server 104 includes a processor 130, input/output devices 132, a bus 134, and a network interface circuit 136 to provide connectivity to network 106. The server 104 includes a memory 140 connected to the bus 134. The memory 140 stores instructions executed by processor 130. In particular, the memory 140 stores a facial recognition module 142. The memory 140 also stores a master facial template collection 144, which includes facial templates for images associated with all client devices 102_1 through 102_N that utilize the client module 126. The memory 140 also stores an archive module 146, which includes instructions executed by processor 130 to implement batch mode processing of information in the master facial template collection 144 to selectively distribute images to client devices 102_1 through 102_N.

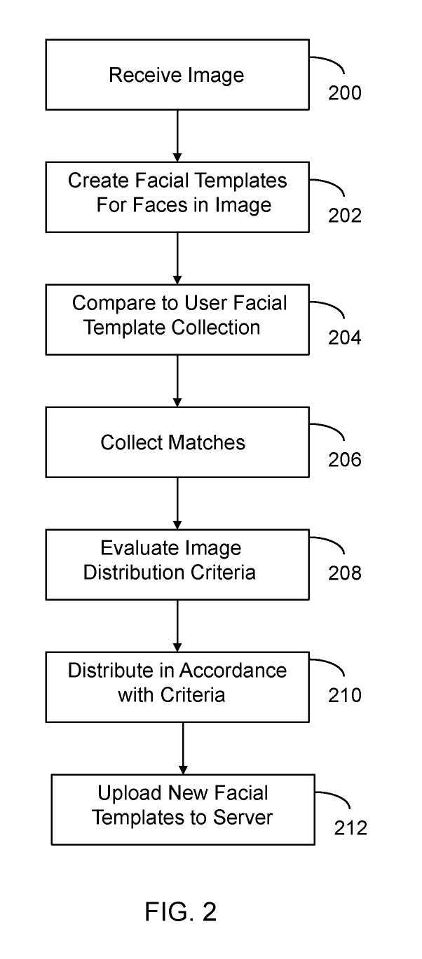

FIG. 2 illustrates processing operations associated with an embodiment of the client module 126. An image is received 200. The image may be from a camera associated with the client device. Alternately, the image may have been received via network 106 from another client device. Alternately, the image may be from a camera roll stored by the client device that has not been processed by the client module 126 earlier.

Facial templates are created for faces in the image. Any number of techniques may be used to create the facial templates. Typically, the facial templates characterize features of a user face, such as the relative position, size and shape of the eyes, nose, cheekbones and jaw.

The facial templates for the faces in the image are compared to a user facial template collection 204. As previously indicated, each client device stores a user facial template collection 124 that includes facial templates for individuals that appear in digital images processed by a client device. The comparison operation is used to find matches between facial templates in the currently processed image and facial templates in the user facial template collection. The matches may be identified using a convolution neural network. In one embodiment, the convolution neural network has multiple convolution layers that use Max-Feature-Mapping.

The matches are collected 206. Image distribution criteria is then evaluated 208. The image distribution criteria specifies what types of images should be distributed. That is, whether using a set of default settings or configured settings, the image distribution criteria establish the type of image that should be distributed. For example, the image distribution criteria may specify parameters regarding an individual or individuals that should appear in an image in order to initiate distribution of the image. The image distribution parameters may specify individuals that should receive a processed image and individuals that should not receive a processed image.

The image distribution parameters may include temporal parameters associated with the distribution, such as a date and time for the distribution.

For example, the client module 126 may be configured such that a first user is always sent an image when the first user appears in any new image associated with the client devices 102_1 through 102_N. The client module 126 may be configured such that an image of a juvenile is never distributed. The client module 126 may be configured such that an image with a first user and a second user, say a husband and wife, may be distributed, but an image with the first user or the second user with other individuals is not distributed.

Observe that the disclosed technique allows for the intelligent distribution of digital images that are likely to be of interest to a recipient. In one mode, a user always receives an image in which the user appears. This allows the user to monitor reputation and potentially limit the distribution of an unflattering digital image.

The image is distributed in accordance with the image distribution criteria 210. A new image will typically be distributed shortly after it is received at the client device. However, the client module 126 may be configured for delayed distribution of the image, such as on a one year anniversary of the date of the image. Finally, new facial templates are uploaded to the server 212. New facial templates are facial templates that do not currently exist in the user facial template collection 124. Uploading the new facial templates to the server 104 allows for the construction of the master facial template collection 144.

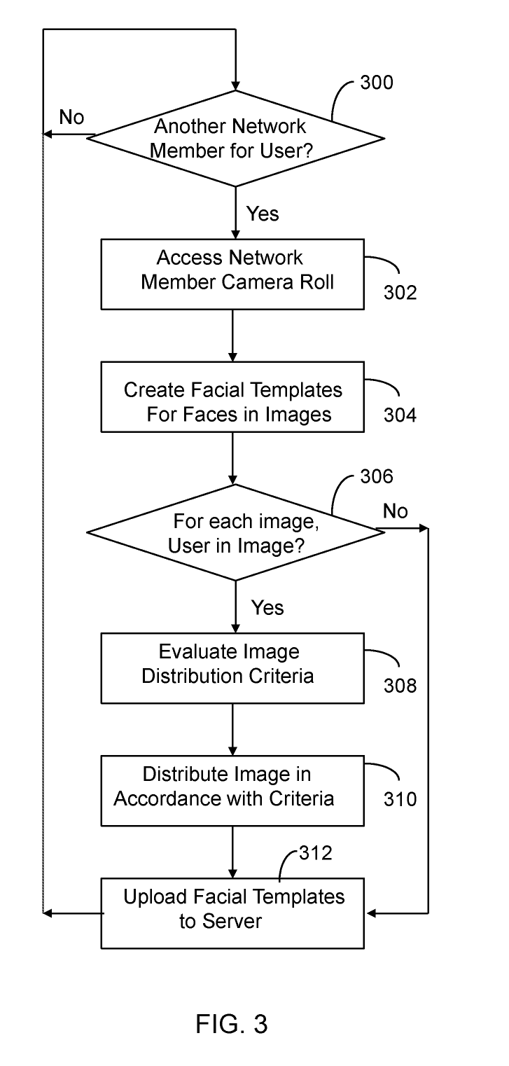

FIG. 3 illustrates processing operations associated with the client module 126 in a different modality. For example, the client module 126 may determine whether a user has a new network member with digital images. A network member is a client device with a client module 126 that the user has designated as an acquaintance. If such a network member exists (300—Yes), the camera roll of the network member is accessed 302. The camera roll may be on a client device associated the network member. Alternately, the camera roll may be on a server hosting a social network application (e.g., Facebook®) that includes an application program interface that allows one to obtain social network contract information, images and the like. The operation to access a network member camera roll 302 may also include an operation to access a list of contacts associated with the network member. The list of contacts may be on the client device of the network member or may be available via the social network application.

By obtaining a list of contacts, the client module 126 is able to communicate with individuals that are not currently members of the network. For example, if a user assigns an identity to an individual in a digital image and that individual is in the list of contacts, the contact information can be used to send the digital image to the individual. Thus, the individual receives an image of interest and is afforded the opportunity to become a network member and thereby consistently obtain images of interest.

For each collected image, it is determined whether the user is in the image 306. Alternate criteria may be used, such as whether the image includes the network member or the image includes both the user and the network member. In the event of a criteria match (306—Yes), image distribution criteria is evaluated 308. The image distribution criteria 308 is configurable. It may specify that the image may be immediately distributed. Alternately, it may specify that one new image be distributed per day until all images have been distributed. The image distribution criteria may specify that the image be distributed on the one year anniversary of the date of the image. The image is then distributed in accordance with the criteria 310.

The image may be distributed in a text, as a post to a social network and the like. Finally, new facial templates are uploaded to the server 312. The new facial templates are templates that do not have a match in the user facial template collection 124.

The automated processing of FIGS. 2 and 3 result in client device processing improvements. In particular, utilizing the distribution criteria (in a configured mode or a default mode), the client device systematically processes digital images without input from the user. Reduced user input processing results in faster operation of the client device and fewer processor cycles. It should be appreciated that the matching process may be used to delete photographs. For example, images that include a former friend may be automatically deleted. This results in improved memory utilization for the client device.

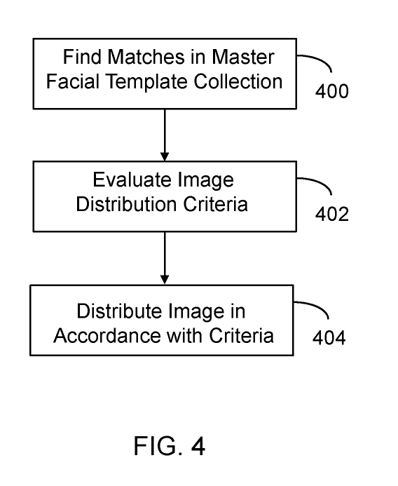

FIG. 4 illustrates operations performed by the server 104 in accordance with an embodiment of the invention. The archive module 146 operates on the master facial template collection 144. The facial recognition module 142 on the server 104 may operate in the same manner as the facial recognition module 122 on the client 102. As previously indicated, the master facial template collection 144 is an aggregation of facial templates for all facial images collected by client module 126 of client devices 102_1 through 102_N.

The archive module 146 is configured to find matches in the master facial template collection. The match criteria is configurable. For example, a first user may specify that she wants to see any instance of her image in the master facial template collection that does not exist in her user facial template collection 124. Alternately, the first user may specify that she wants to see any instance of her image in the master facial template collection in which she appears with another member of her social graph.

For each match, image distribution criteria is evaluated 402. The image distribution criteria may include image distribution criteria of the type discussed in connection with the client module 126. However, given the potentially large number of matches based upon the master facial template collection, it is desirable to have more rigorous image distribution criteria. For example, the image distribution criteria may limit a distributed image to one a day or one a week. The image distribution criteria may specify a preference for the distribution of old images or new images. Finally, an image is distributed in accordance with the criteria.

Observe that the mining of images in the master facial template collection may result in a user receiving images of herself that she has never seen before. That is, a network member may contribute images with a facial template for the user. Such images may not have ever been shared with the user. With the disclosed system, such images may be automatically distributed to the user in accordance with a schedule specified by the user. Thus, the user enjoys the benefit of access to new images of herself, yet is in a position to control how many such images she receives so as not to be overwhelmed by excessive messages and burdensome utilization of memory to accommodate superfluous images.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. An apparatus, comprising:
a processor;
a network interface circuit connected to the processor to provide connectivity to a network;
a memory connected to the processor and the network interface circuit, the memory storing instructions executed by the processor to:
receive a digital image,
create facial templates for faces in the digital image,
compare the facial templates to a user facial template collection to selectively identify matches between the facial templates and stored user facial templates in the user facial template collection,
evaluate image distribution criteria for the matches,
send to the network, for distribution to selective client devices, the digital image in accordance with the image distribution criteria, and
upload to a server, via the network, new facial templates from the digital image that do not correspond to stored user facial templates in the user facial template collection.

2. The apparatus of claim 1 wherein the digital image is received from a camera associated with the apparatus.

3. The apparatus of claim 1 wherein the digital image is received from the network.

4. The apparatus of claim 1 wherein the image distribution criteria specifies individuals to receive the digital image.

5. The apparatus of claim 1 wherein the image distribution criteria specifies individuals to block from receiving the digital image.

6. The apparatus of claim 1 wherein the image distribution criteria specifies date and time parameters to distribute the digital image.

7. The apparatus of claim 1 further comprising instructions executed by the processor to:
access, via the network, digital images of an individual known to a user,
create facial templates for faces in the digital images,
for each image, determine if the user is in the image to selectively establish a match,
for each match, evaluate image distribution criteria,
for each match, distribute an image in accordance with the image distribution criteria, and
upload to the server, via the network, new facial templates from the digital images that do not correspond to stored user facial templates in the user facial template collection.

8. The apparatus of claim 7 wherein the digital images are accessed on a client device associated with the individual.

9. The apparatus of claim 7 wherein the digital images are accessed on a server hosting a social network that the individual participates within.

10. The apparatus of claim 7 further comprising instructions executed by the processor to access a contact list for the individual.

11. The apparatus of claim 1 in combination with the server, wherein the server includes instructions executed by a server processor to:
find user matches within a master facial template collection,
evaluate image distribution criteria for the user matches, and
distribute images via the network in accordance with the image distribution criteria.

12. The apparatus of claim 1 wherein the instructions to selectively identify matches utilize a convolutional neural network.
